(19) United States
(12) Patent Application Publication
(10) Pub. No.: US 2023/0247142 A1
(43) Pub. Date: Aug. 3, 2023

(54) METHOD AND SYSTEM FOR MANAGEMENT OF MULTI-PARTY COMMUNICATIONS

(71) Applicant: Christiana Care Health System, Inc., Wilmington, DE (US)

(72) Inventors: Jonathan Meade, Newark, DE (US); John DiGiovanni, Wilmington, DE (US); John Evans, Landenberg, PA (US)

(21) Appl. No.: 18/103,988

(22) Filed: Jan. 31, 2023

Related U.S. Application Data
(60) Provisional application No. 63/304,961, filed on Jan. 31, 2022.

(51) Int. Cl. H04M 3/56

(52) U.S. Cl. CPC H04M 3/56; H04M 2203/5018; H04M 2203/5009

(57) ABSTRACT

A method and system for management of multi-party communications that is capable of intelligently assessing a first party/requestor's need and automatedly matching the first party's need to a suitable second party resource that is most probable to meet that need in an efficient manner. The system effectively serves as a chatbot-based (text-based or voice-based) switchboard operator that allows requestors to state a need for a service or consultation, and then automatedly have that need researched and/or matched to the most appropriate resource/service provider based on real-time automated inquiry and/or known data from past research. Further, the system is capable of contacting one or more resources/service providers, confirming that a particular resource/provider can meet the current need, and also coordinating/facilitating a communication session between the first party/requestor and the second party/resource without the need for human intervention.

### CROSS-REFERENCE TO RELATED APPLICATION

This application claims the benefit of priority under 35 U.S.C. § 119(e) of U.S. Provisional Patent Application No. 63/304,961, filed Jan. 31, 2022, the entire disclosure of which is hereby incorporated herein by reference.

### FIELD OF THE INVENTION

The present invention relates generally to the field of computer networking and computerized communications sessions, and more particularly to a method and system for intelligent management of multi-party communications.

### DISCUSSION OF RELATED ART

Communications networks for enabling multi-party communications, e.g., by telephone, e-mail and/or SMS/text, are well-known in the art. Often, a first party wishes to communicate with a second party, identifies contact information for the second party, and then prepares and/or initiates a communication to/with the second party using the second party's contact information, e.g., by placing a telephone call to a specific person have a respective telephone number, using a telephone.

In accordance with the present state of the art, a first party seeking to communicate with a second party generally needs to know, look up, and/or request assistance in finding a suitable person or consultant to deliver a specific service needed. After the individual believes that a suitable second party has been identified, e.g., as a viable resource for a particular service/information need, then the first party needs to identify contact information for that resource/second party, and then attempt to contact the resource/second party (sometimes needing to make repeated attempts to contact the second party, or to contact other parties if the particular second party is unavailable). In the end, the second party may or may not respond, provide value, or have capacity to deliver the information and/or service needed, resulting in wasted time and effort on the part of the first party.

In certain contexts, a first party wishes to communicate with a second party to fulfill a particular need, yet the identity of the second party is initially unknown and/or undetermined. For example, in a healthcare context, a first party may wish to communicate with a suitable person/consulting entity to obtain a specific service, information or consultation, yet is initially unsure of who that suitable person is. For example, a primary care physician may be providing medical care to a particular patient, and may wish to consult with a specialist to obtain an opinion/medical guidance and/or other information (with respect to medical treatment for the patient) from the specialist's point of view. However, the primary care physician may be initially unsure as to who is a suitable person to contact for such guidance. For example, the primary care physician may be unsure as to whether the primary care physician needs the advice of a nephrologist or other specialist, or may be certain that a nephrologist is needed, but be unsure of who is a nephrologist, or may be aware of a number of persons that are nephrologists, but may be unsure as to which nephrologist has the appropriate expertise, or may be aware of a number of nephrologists with appropriate expertise, but may be unaware of which nephrologist is presently “in-network” with respect to the patient's insurance, or readily available to have a discussion with the primary care physician for obtaining such an opinion/medical guidance or other information.

Current assistive communication systems depend on a tightly coupled, known network of individuals to allow for connections to be made or a rudimentary call list that places all the decision making on the person attempting to find a suitable second party/service provider. The first party user must know the need as well as the service and/or second party/service provider that will meet that need in order to attempt to establish a communication channel directly with that suitable second party/service provider. Often, the user has no shared understanding of the current capacity of the second party/service provider until a call to the second party/service provider is made.

What is needed is a system that can lessen the burden on the first party, and/or reduce or eliminate the need to identify which second party/resource has capacity and will be the most relevant to the first party's need, affording the first party the opportunity to avoid inefficiencies in obtaining access to an available, suitable second party, and to instead continue to be productive at other tasks.

### SUMMARY

The present invention provides a method and system for management of multi-party communications that is capable of intelligently assessing a first party/requestor's need and matching the first party need to a suitable second party resource that is most probable to meet that need in an efficient manner. The system effectively serves as a chatbot-based switchboard operator that allows requestors to state a need for a service or consultation, and then automatedly have that need researched and/or matched to the most appropriate resource/service provider based on real-time automated inquiry and/or known data from past research. Further, the system is capable of contacting one or more resources/service providers, confirming that a particular resource/provider can meet the current need, and also coordinating/facilitating a communication session between the first party/requestor and the second party/resource without the need for human intervention.

Accordingly, after the system has identified the requestor's need/requested resource, the requestor can continue with other tasks and wait for the system to asynchronously facilitate a communication session with a service provider. Further, after a resource need has been identified, the system manages/routes the resource request to a relevant resource providers that has the best chance of meeting that need based on trained models (coupled with known request volume), and attempt to contact a resource provider via phone, text, or software application. The system then starts an interactive session with the resource service provider to validate the contact's identity, confirm the service needed, and confirm the contact has the capacity to meet the need/provide the requested resource. If any of the above is not met, the system will record why the match was not made and attempt a session with the next most-likely resource provider. The system uses success and failure to inform its future triage functionality.

After the validation process is complete, the system notifies the original requestor that a resource has been found and is available to provide the requested resource. A communication session is then started for the two parties (requestor and resource provider) to facilitate communication between them. The system learns based on success/failure/other datapoints recorded for each interaction, including if the need was successfully met between the user and the second party. Information is logged to inform selection of resource providers for meeting future resource requests. This serves to prioritize the resource providers the system attempts to contact based on time of day, volume of requests, and success or failure rates.

At any point during this process, if a connection fails to be made, or repeated attempts have been unsuccessful, the system will escalate the need to a human operator or follow up with the initial requestor regarding the status of fulfilling the request.

### BRIEF DESCRIPTION OF THE FIGURES

An understanding of the following description will be facilitated by reference to the attached drawings, in which:

FIG. 1 is a system diagram showing an exemplary network computing environment in which the present invention may be employed;

FIG. 2 is a schematic view of an exemplary computing system in accordance with an exemplary embodiment of the present invention; and

FIGS. 3-9 illustrate further exemplary operation of the system of FIG. 1.

### DETAILED DESCRIPTION

The present invention provides a method and system for management of multi-party communications that is capable of intelligently assessing a first party/requestor's need and matching the first party need to a suitable second party resource that is most probable to meet that need in an efficient manner. The system effectively serves as a chatbot-based switchboard operator that allows requestors to state a need for a service or consultation, and then automatedly have that need researched and/or matched to the most appropriate resource/service provider based on real-time automated inquiry and/or known data from past research. Further, the system is capable of contacting one or more resources/service providers, confirming that a particular resource/provider can meet the current need, and also coordinating/facilitating a communication session between the first party/requestor and the second party/resource without the need for human intervention.

Accordingly, the system of the present invention is capable of acting as an intelligent, AI-based chatbot communication operator, to understand a requestor's need, intelligently route communication requests, interface with and connect relevant parties, and track communication interactions between parties. Accordingly, the present invention may be helpful, for example, to companies that benefit from efficient communication to meet business needs within the company, to companies that benefit from efficiently aligning needs to resources available outside the company, to companies that would benefit from asynchronous communication channel coordination, and to individuals that need a service or consultant for a specific need that don't have the time to vet manually by contact potential service provider options.

More particularly, the present invention provides a system that intelligently triages a requestor's need for a resource, and effectively directs/escalates the requestor's inquiry to the resource that is most probable to meet that need in the most efficient manner. In certain embodiments, the system acts as a chatbot operator allowing users to state the need for a service (e.g., a medical consultation), have that need matched to the most appropriate resource (e.g., service provider) based on known data, reach out to that resource (e.g., service provider), confirm that the resource (e.g., service provider) is available and able to meet the need, and coordinate a communication session between both parties without the need for human intervention.

Currently an individual needs to know, look up, or request assistance in finding a person or consultant or other resource available and able to deliver a specific service needed. Once the individual believes a viable resource is identified, the individual needs to attempt to contact (sometimes making repeated attempts to multiple parties) the resource. In the end, the contact may or may not respond, provide value, or have capacity to deliver the service needed resulting in wasted time and effort. The present invention provides a system that eliminates the need to identify what resource has capacity and will be the most relevant to the user's need, allowing the user to continue being productive at other tasks.

The system's functionality is implemented by a computerized device and/or computing system comprising conventional hardware and software as well as special-purpose software in accordance with the present invention.

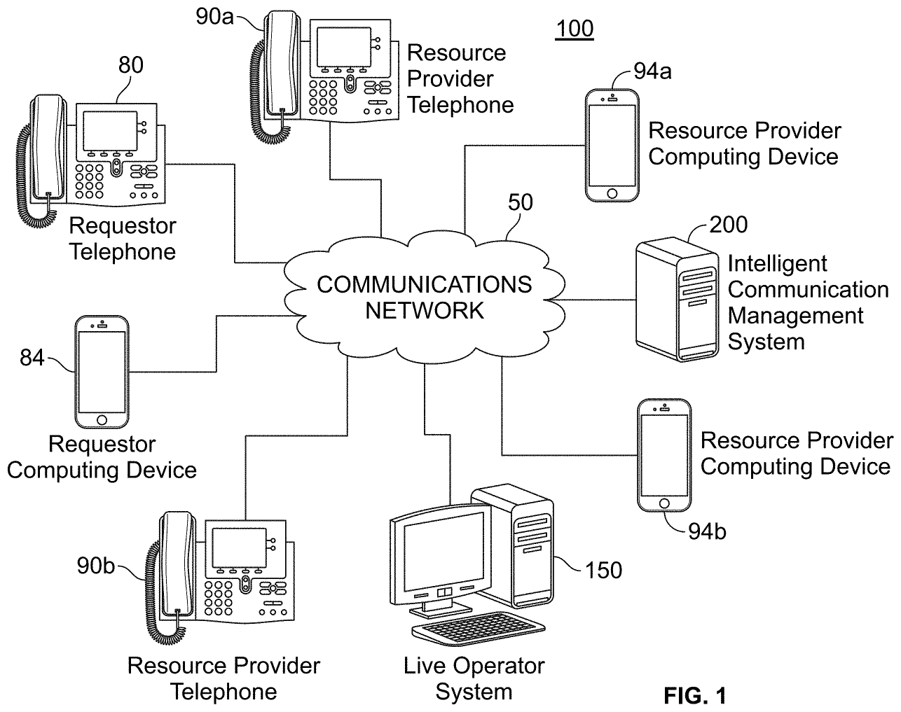

According to illustrative embodiment(s) of the present invention, various views are illustrated in FIGS. 1-9 and like reference numerals are used consistently throughout to refer to like and corresponding parts of the invention for all of the various views and figures of the drawings.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

### System Environment

An exemplary embodiment of the present invention is discussed below for illustrative purposes. FIG. 1 is a system diagram showing an exemplary network computing environment 100 in which the present invention may be employed. As shown in FIG. 1, the exemplary network environment 100 includes conventional computing hardware and software for communicating via a communications network 50, such as the Internet, etc., using a Requestor (e.g., personal) Device, such as a Requestor (e.g., desktop) Telephone 80 or a Requestor Computing Device 84, which may be, for example, one or more personal computers/PCs, laptop computers, tablet computers, smartphones, or other computing device hardware including computerized/networked communication hardware/software/functionality. Additionally, as shown in FIG. 1, the exemplary network environment 100 includes conventional computing hardware and software for communicating via a communications network 50, such as the Internet, etc., using a Resource Provider (e.g., service provider) Device, such as a Resource Provider Telephone 90a, 90b or a Resource Provider Computing Device 94a, 94b, which may be, for example, one or more personal computers/PCs, laptop computers, tablet computers, smartphones, or other computing device hardware including computerized/networked communication hardware/software/functionality.

In accordance with a certain aspect of the present invention, one or more of the Requestor Computing Device 84 and/or the Resource Provider Computing Devices 94a, 94b may store and execute an “app” or other purpose-specific application software in accordance with the present invention, although this is not required in all embodiments.

In accordance with the present invention, the network computing environment 100 further includes Intelligent Communication Management System (ICMS) 200. In this exemplary embodiment, the ICMS 200 is operatively connected to the Requestor Computing Device 84 and the Resource Computing Devices 94a, 94b for data communication via the communications network 50. Additionally, the ICMS 200 is operatively connected for data communication with the Requestor Telephone 80 and the Resource Telephones 90a, 90b for data (e.g., voice) communication via the communications network 50. Hardware and software for enabling communication of data by such devices via such communications networks are well known in the art and beyond the scope of the present invention, and thus are not discussed in detail herein.

### Intelligent Communication Management System

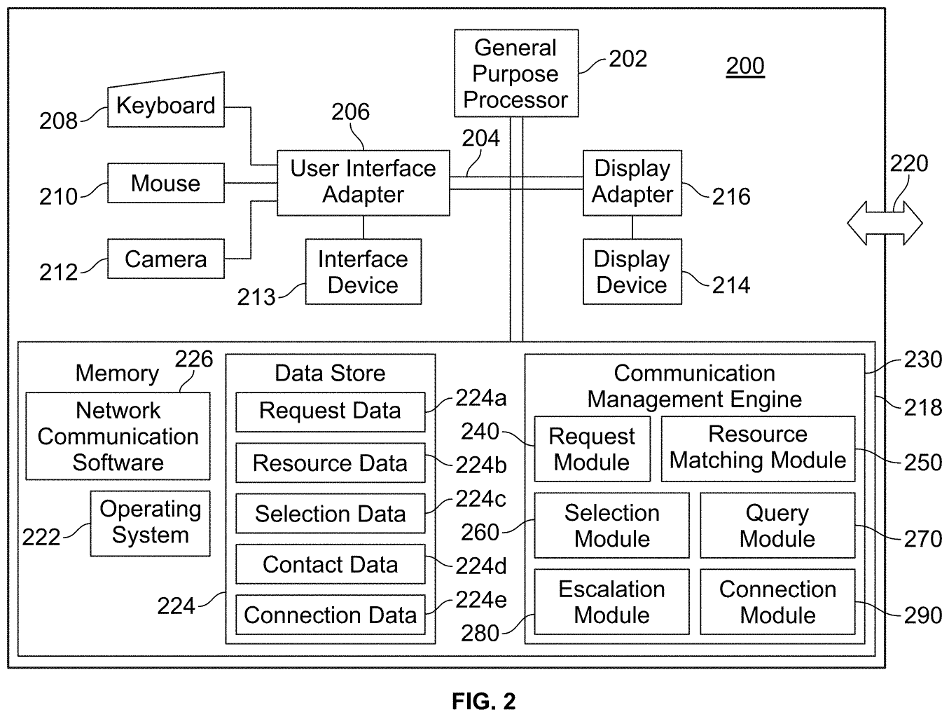

FIG. 2 is a block diagram showing an exemplary Intelligent Communication Management System (ICMS) 200 in accordance with an exemplary embodiment of the present invention. The ICMS 200 is a special-purpose computer system that includes conventional computing hardware storing and executing both conventional software enabling operation of a general-purpose computing system, such as operating system software 222, network communications software 226, and specially-configured computer software for configuring the general-purpose hardware as a special-purpose computer system for carrying out at least one method in accordance with the present invention. By way of example, the communications software 226 may include conventional web server software, and the operating system software 222 may include iOS, Android, Windows, Linux software.

Accordingly, the exemplary ICMS 200 of FIG. 2 includes a general-purpose processor, such as a microprocessor (CPU), 102 and a bus 204 employed to connect and enable communication between the processor 202 and the components of the presentation system in accordance with known techniques. The exemplary presentation system 200 includes a user interface adapter 206, which connects the processor 202 via the bus 204 to one or more interface devices, such as a keyboard 208, mouse 210, and other interface devices 212, which can be any user interface device, such as a camera, microphone, touch sensitive screen, digitized entry pad, etc. The bus 204 also connects a display device 214, such as an LCD screen or monitor, to the processor 202 via a display adapter 216. The bus 204 also connects the processor 202 to memory 218, which can include a hard drive, diskette drive, tape drive, etc.

The ICMS 200 may communicate with other computers or networks of computers, for example via a communications channel, network card or modem 220. The ICMS 200 may be associated with such other computers in a local area network (LAN) or a wide area network (WAN), and may operate as a server in a client/server arrangement with another computer, etc. Such configurations, as well as the appropriate communications hardware and software, are known in the art.

The ICMS 200 is specially-configured in accordance with the present invention. Accordingly, as shown in FIG. 2, the ICMS 200 includes computer-readable, processor-executable instructions stored in the memory 218 for carrying out the methods described herein. Further, the memory 218 stores certain data, e.g., in one or more databases or other data stores 224 shown logically in FIG. 2 for illustrative purposes, without regard to any particular embodiment in one or more hardware or software components.

Further, as will be noted from FIG. 2, the ICMS 200 includes, in accordance with the present invention, a Communication Management Engine (CME) 230, shown schematically as stored in the memory 218, which includes a number of additional modules providing functionality in accordance with the present invention, as discussed in greater detail below. These modules may be implemented primarily by specially-configured software including microprocessor—executable instructions stored in the memory 218 of the ICMS 200. Optionally, other software may be stored in the memory 218 and and/or other data may be stored in the data store 224 or memory 218.

As shown in FIG. 2, the exemplary embodiment of the ICMS 200 includes a Request Module (RM) 240. The RM 240 is responsible for receiving a requestor's request via the network, identifying a requested resource, such as a consultation with a service provider (e.g., by parsing, natural language processing, keyword search or the like). The RM 240 may be responsible for obtaining confirmation that the particular resource requested has been properly identified, which may involve transmitting data to the Requestor Computing Device to cause display of text, generation of audible speech, etc. For example, this may involve displaying or otherwise communicating the name of a known resource provider that matches, or best matches the requested resource, to confirm that it is a match, or verbally expressing the name of the resource as a confirmation method with the requestor, e.g., in voice-based environments rather than the text-based environment described in the exemplary embodiment. The RM 240 may store request-associated data as Request Data 224a in the data store 224 and/or may reference Resource Data 224b stored in the data store 224 identifying available resources as part of identifying a particular resource requested in view of the Requestor's request.

In accordance with the present invention, the exemplary embodiment of the ICMS 200 shown in FIG. 2 also includes a Resource Matching Module (RMM) 250. The RMM 250 is responsible for identifying one or more available resource providers (e.g., service providers) as matching the requestor's request for a resource (such as a request for a consultation with a particular type of service provider). This may involve retrieval of data from the Resource Data 224b stored in the data store and comparison of resource provider information identified in the Resource Data 224b to information contained in the request, so that a set of suitable resource providers may be identified as possible candidates for providing the resource requested by the Requestor. For example, if the requestor requests a resource in the nature of a consultation with a “liver specialist” or a “nephrologist,” then the RMM 250 may identify one or more nephrologists (service providers) suitable for servicing the request.

In accordance with the present invention, the exemplary embodiment of the ICMS 200 shown in FIG. 2 also includes a Selection Module (SM) 260. The SM 260 is responsible for selecting one or more matching resources (e.g., service providers) that are preferable for servicing the request for the resource. For example, this may be used to select a best or preferred nephrologist or set of nephrologists from a larger set of nephrologists that otherwise meet the resource request criteria. For example, the SM 260 may select or rank in priority order a set of nephrologists for servicing a request (e.g., for consultation with a nephrologist) based on additional information, such as a sub-specialization, a geographical location, membership in a certain provider or insurance network, or on other relevant bases. Such information may be contained within the Resource Data 224b as characteristics associated with each resource provider. Additionally, the SM 260 may select or rank in priority order a set of service providers (e.g., nephrologists) for servicing a request (e.g., for consultation with a nephrologist) based on additional information that is monitored and tracked by the ICMS 200, such as system-observed availability of the service provider, system-observed service provider response time, ratings of service provider effectiveness, etc. Such data may be stored as Selection Data 224c in the data store 224, and may be referenced by the SM 260 for this purpose.

In accordance with the present invention, the exemplary embodiment of the ICMS 200 shown in FIG. 2 also includes a Query Module (QM) 270. The QM 270 is responsible for contacting a resource in an initial communication session and querying the resource provider as to present availability, etc. for providing the requested resource. This may involve the QM 270's retrieval of resource contact information, stored as Contact Data 224d in the data store 224, such as a telephone number, for each suitable resource provider identified by the Selection Module 260. In certain embodiments, this may involve contacting one or more resource providers using respective contact information in a ranked order determined by the SM 260. In certain instances, this may involve use of an external telephone connectivity system/service for providing for automated voice-type interaction with the ICMS 200, e.g., as computer-generated simulated speech. For example, the external telephone connectivity system/service could initiate an outgoing request, (in this case, call a telephone number of a service provider) and iterate through a list of confirmation criteria by providing audio verbalizing each question to the intended resource provider over the telephone-based connection, and interpreting spoken responses from that resource provider, e.g., as a voice-based user interface of a chatbot. The QM 270 may store data indicating successful and/or unsuccessful contact attempts, successful and/or unsuccessful matching of each resource provider to each resource request, etc. as Connection Data in the data store 224. Such data may be used in conjunction with AI or machine learning techniques as part of feedback to the system to inform selections of resource providers by the SM 240, based on past observations by the system.

In the exemplary embodiment shown in FIG. 2, the ICMS 200 further includes an Escalation Module (EM) 280. In embodiments in which the ICMS 200 includes an EM 280, the EM 280 is responsible for handling unsuccessful query attempts made by the QM 270. For example, this may occur when an attempt to contact a resource provider is successful, but the resource provider desired is not available, and an alternative resource provider should be sought. By way of further example, this may occur when an attempt to contact a resource provider is unsuccessful, in which case the EM 280 may be configured to repeat an attempt to contact the resource provider(s) and/or contact an alternative resource provider, e.g., a next-ranked resource provider identified by the RMM 250 and/or SM 260. This may be performed according to any suitable predetermined logic of the EM 280.

In accordance with the present invention, the exemplary embodiment of the ICMS 200 shown in FIG. 2 also includes a Connection Module (CM) 290. The CM 290 is responsible for enabling or facilitating a communication session (e.g., by telephone) between the requestor and a particular suitable resource (e.g., service provider), after the suitable resource provider has been selected by the SM 260, and the suitability and availability of the resource provider has been automatedly confirmed by the QM 270. In certain embodiments, this may involve acting somewhat like a telephone switchboard operator to connect the requestor and the resource provider (e.g., via telephone) for discussion by telephone. In other embodiments, the requestor and resource provider may be connected for communication by text message, e-mail message or via other communication channels, e.g., after the CM 290 has facilitated the connection (e.g., by directly connecting them, providing a communication channel between them, or by providing notification to contact each other, e.g., by providing respective contact information).

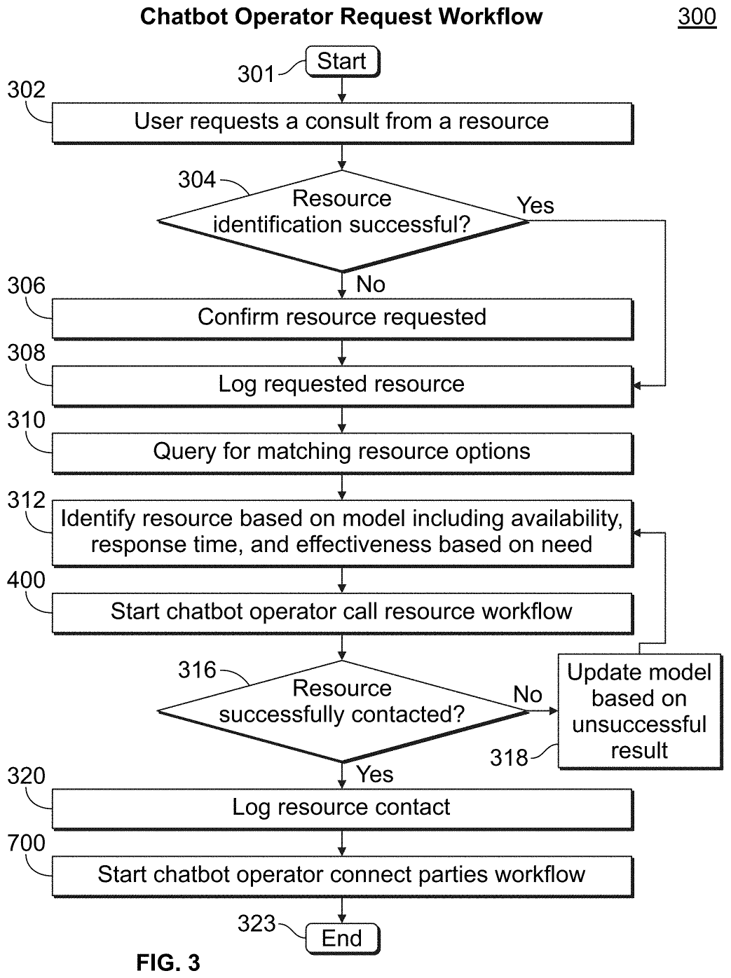

Exemplary operation of the system of FIGS. 1 and 2 is illustrated in the exemplary flow diagrams of FIGS. 3-9. Referring now to the exemplary Request Workflow method shown in the flow diagram of FIG. 3, the exemplary method 300 starts 301 with a user's (Requestor's) request for a resource 302, such as a consultation with a particular type of service provider and/or for a particular type of service. This may involve receipt of a data communication from a Requestor Device 80, 84 at the ICMS 200. The Request Module 240 may process the request data received to determine which particular resource/type of resource is being requested, as shown at 304. If it is not able to make such a determination, it may request confirmation of the resource requested by transmitting data and/or playing an audio message back to the Requestor, e.g., by transmitting data from the ICMS 200 back to the Requestor's Device 80, 84 via the communications network 50, as shown at 306. After the particular resource requested has been successfully identified, the RM 240 may store data logging the request for the particular resource requested (e.g., as Request Data 224a), as shown at 308, and as will be appreciate from FIGS. 2 and 3.

Next, the method involves identifying one or more resources (e.g., service provider) options matching the request (i.e., well-suited to provide the requested resource). This may be performed by the Resource Matching Module 250, and may involve the RMM 250 referencing (e.g., querying) Request Data 224a and/or Resource Data 224b indicating which resource providers are known to the ICMS 200 as shown at 310. In certain embodiments, a set of resource providers may be identified by the RMM 250 that matches the request criteria.

Next, the method involves selecting a suitable resource provider, as shown at 312 in FIG. 3. This may be performed by the Selection Module 260, and may be used to identify a subset of the suitable resource providers that are preferred, and should be contacted by the ICMS 200. In certain embodiments, this may involve ranking a plurality of resource providers, or selecting the best resource provider from a group of resource providers. The SM 260 may do so according to any suitable logic, and may reference Selection Data 224c stored in the data store 224 to do so. For example, the SM 260 may select a particular resource provider on the basis of availability, an average response time to a request, ratings, etc.

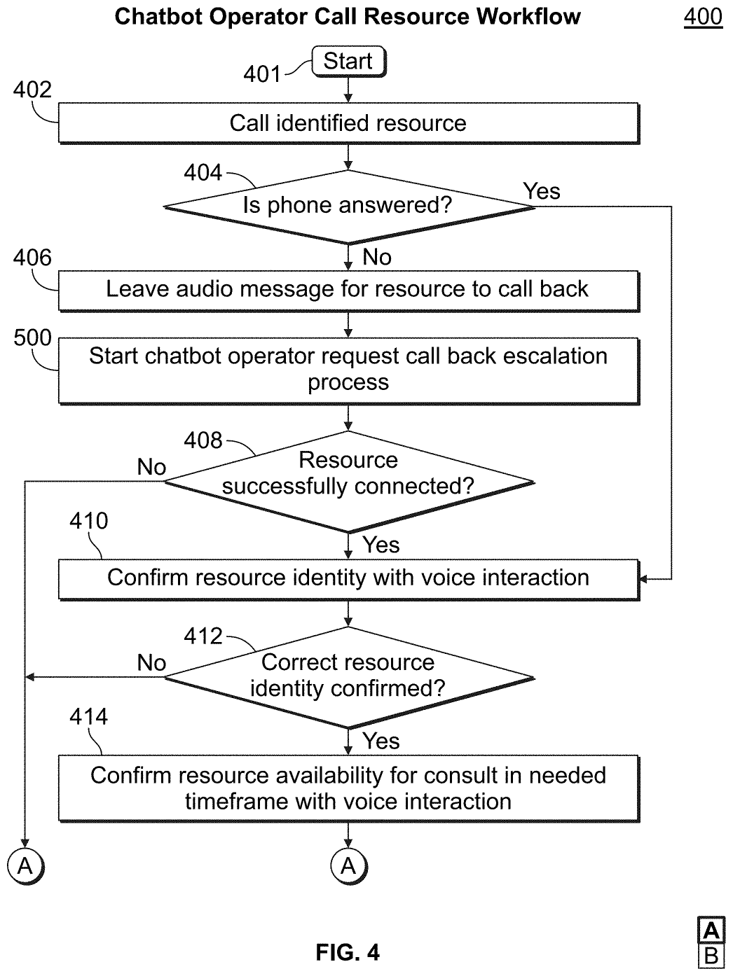

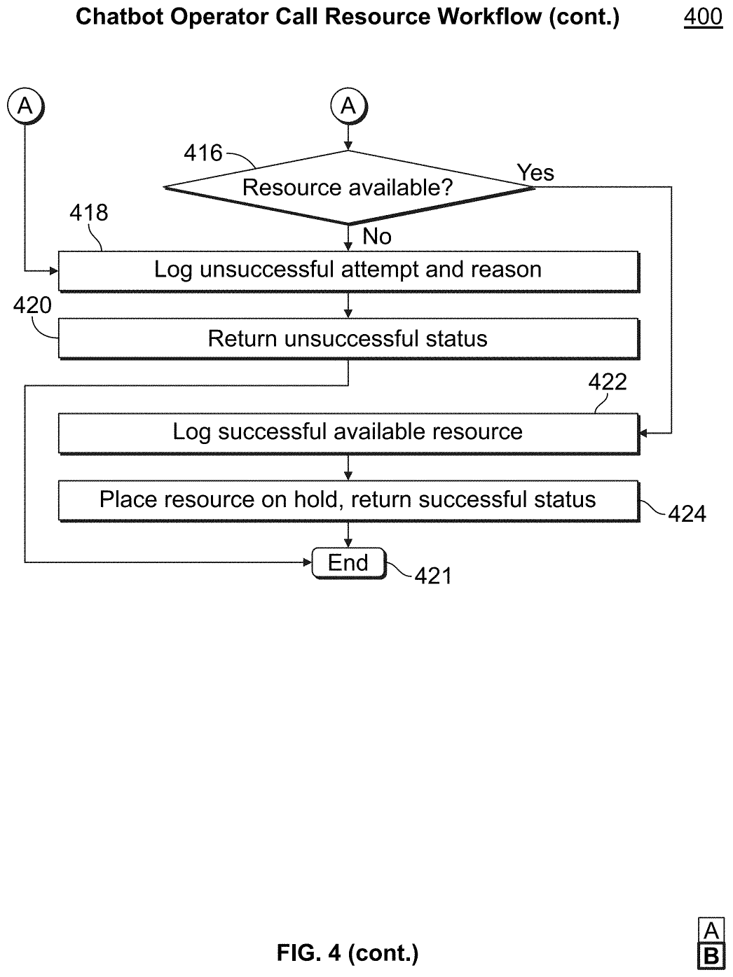

After at least one preferred resource has been identified by the SM 260, the ICMS then starts an automated query process involving automated communication with (e.g., placement of a telephone call to) a resource provider, e.g., as part of a Call Resource Workflow, as shown at 400, and as discussed in greater detail with reference to FIG. 4. The automated query process may serve somewhat like a chatbot-based (text-based or voice-based) switchboard operator.

Referring still to FIG. 3, if the desired resource is not successfully contacted as part of the Call Resource Workflow, as shown at 316, then the stored data and/or decision logic/model for selecting a suitable/best resource is then updated, as shown at 318, and method flow continues to 312, where a next (e.g., next-best) resource may then be selected and contacted in iterative fashion, as will be appreciated from FIG. 3.

If, however, the desired resource is successfully contacted as part of the Call Resource Workflow, as shown at 316, then the system will log/record the successful contact (e.g., as part of the Contact Data 224d), as shown at 320, and the method will proceed to perform the Connect Parties Workflow (e.g., under control of the Connection Module 290), as shown at 700, and the exemplary method ends, as shown at 323.

FIG. 4 illustrates the Call Resource Workflow method referred to in FIG. 3. Accordingly, the exemplary method starts with the QM 270 placing an automated telephone call to the identified resource provider using the relevant contact information. Referring now to the exemplary Call Resource Workflow method shown in the flow diagram of FIG. 4. The Call Resource Workflow method 400 may be performed by the Query Module 270. The exemplary method 400 starts 401 with contacting (e.g., via a text message or telephone call, etc. —in this example, via a telephone call) the identified resource, as shown at 402. Accordingly, the QM 270 initiates a communication session with a first (or next) resource. This may involve retrieval of contact data for a particular (preferred) identified resource provider from the Contact Data 224d stored in the data store 224. Further, this may involve the QM 270 initiating an automated telephone call to a telephone number of the particular (preferred) identified resource provider using the contact data, and in certain embodiments, an external telephone connectivity service or system.

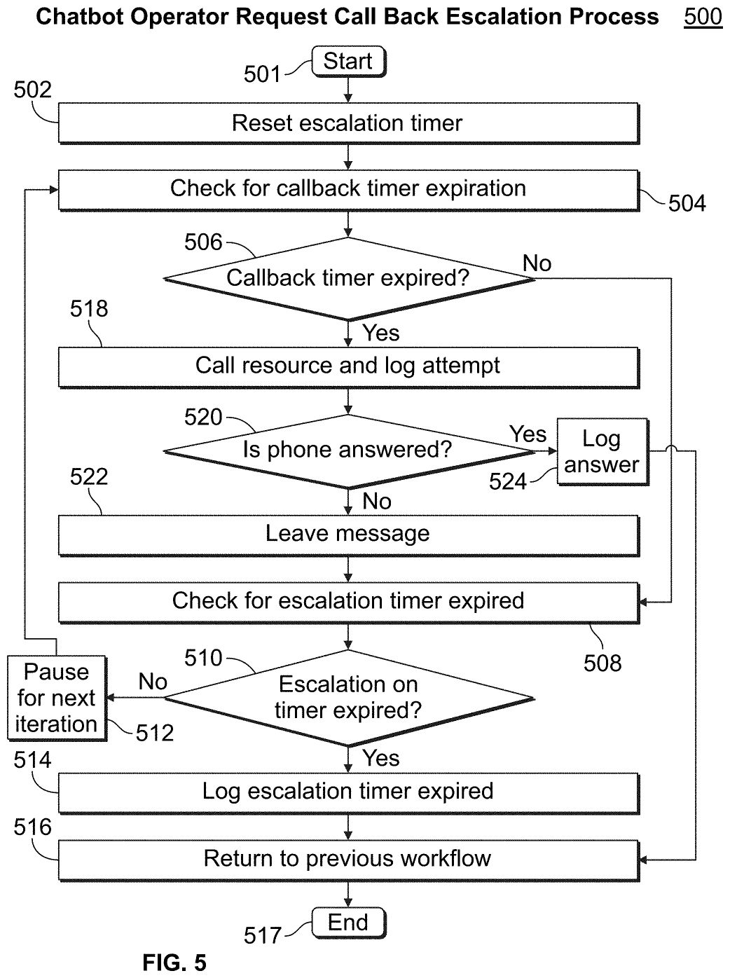

Next, it is determined if the identified resource has been contacted successfully (i.e., if the telephone call is answered), as shown at 404. If the identified resource has not been contacted successfully (e.g., if the telephone call was not answered), then the QM 270 (in this example) leaves an audio message indicating that the resource should call back to the system, as shown at 406. For example, a general-purpose resource call back script could be stored in the system, and be retrieved and processed and verbalized by the chatbot such that the called party hears spoken words/synthetic speech of the script (e.g., “Hello, we are trying to reach [resource provider name]? Please ask [resource provider name] to return this call by calling [telephone number]”). For example, this may involve transmission of data via the communications network 50. The method may then proceed to start the Request Call Back Escalation Process 500, as shown in FIG. 4, and as discussed in greater detail with reference to FIG. 5. It is then determined if the identified resource has been contacted successfully, as shown at 408.

If it is determined at 404 that the call has been answered, or at 408 that the resource has been successfully connected, then the QM 270 confirms the resource's identity, as shown 410. For example, this may involve information exchange to confirm current availability and suitability of the resource. For example, a general-purpose resource provider identity confirmation script could be stored in the system, and be retrieved and processed and verbalized by the chatbot such that the called party hears spoken words/synthetic speech of the script (e.g., “Hello, is your name [resource provider name]? Can you confirm your ID?”).

The QM 270 may then receive a response, e.g., via speech provided by the called resource and associated data transmitted to via the communications network 50. It is then determined if the response indicates that the correct resource identity has been confirmed, as shown at 412.

If so, after the resource provider identity has been confirmed, then it can be determined whether the resource provider can meet the criteria for the need (e.g., for the relevant service, provided within the relevant timeframe, and/or according to other criteria), as shown at 414. This may be performed, for example, using verbalization of a similarly stored script (e.g., “Are you available for a consultation for the next 15 minutes? Are you able to consult on a patient presenting X and Y diagnosis?”). Criteria questions could be scripted based on the identified need and supplemented by specific needs by the requestor (such as a timeframe identified by the requestor).

It is then determined if the resource is available as needed, as shown at 416.

If the QM 270 is unsuccessful in contacting the resource provider (e.g., no answering of the telephone call and/or no call back) as shown at 408, or if the resource is not available at 416, then the QM 270 logs the unsuccessful attempt, as shown at 418, and returns (e.g., displays or stores) an unsuccessful connection status, as shown at 420, and the method ends, as shown at 421. This may involve storing associated data reflecting the failed connection as Connection Data 224e and/or Selection Data 224c for use in making a future selection of a suitable resource to contact, and the Escalation Module 280 may then determine whether to re-attempt contact and/or to identify an alternative (e.g., next best) resource provider to contact, e.g., as determined by the Selection Module 260 and/or Escalation Module 280. This is discussed in greater detail below with reference to FIGS. 5, 6 and 8.

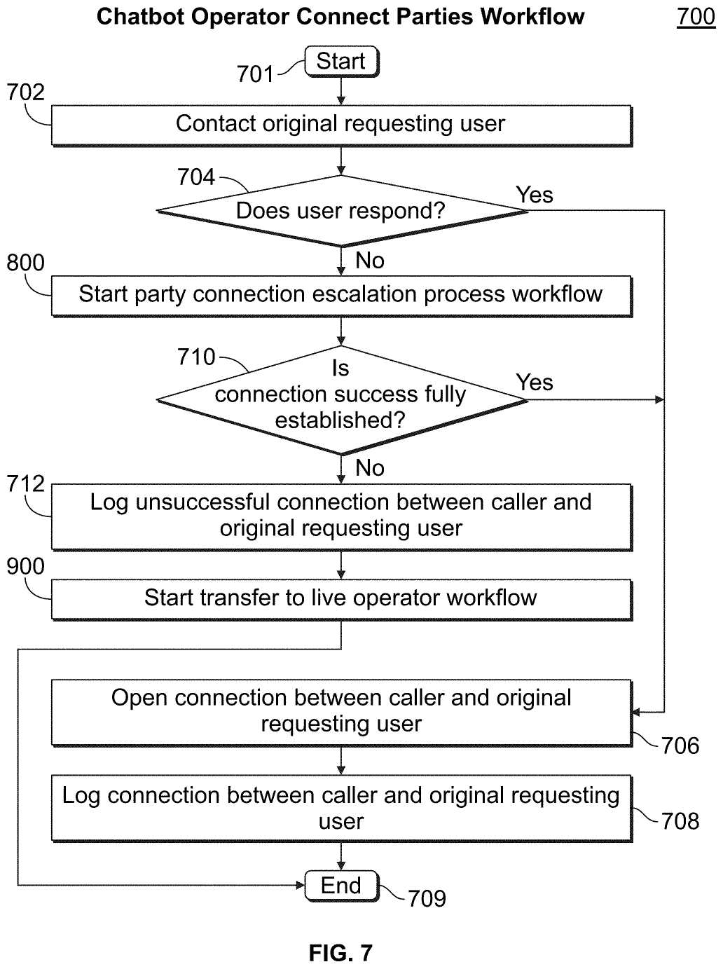

If, however, the QM 270 is successful in contacting the resource provider and the resource is determined to be available as needed at 416, then the QM 270 may log the successful identification of an available resource, as shown at 422. This may involve storing data reflecting this successful contact in the Selection Data 224c and/or in the Connection Data 224e. The QM 270 may then place the resource on hold for next steps, and return a successful connection status, as shown at 424, and this method ends as 41. For example, the Connection Module 290 may subsequently initiate a connection (e.g., acting like a switchboard operator) to connect or facilitate a telephone call (or other communication session) between the requestor and the available resource provider thus identified (e.g., as part of a Connect Parties Workflow, discussed in greater detail below with reference to FIG. 7). By way of example, the Connection Module 290 may place on hold the telephone call with the resource service provider, and then subsequently call or connect the requestor by telephone.

FIG. 5 illustrates an exemplary Request Call Back Escalation Process method 500 of operation of the EM 280 for requesting a call back for the purposes of confirming availability of the resource service provider. Referring now to FIG. 5, this exemplary method begins with starting/resetting an escalation timer, as shown at 502. Next, the EM 280 checks for expiration of a callback timer (started after a previous call was unsuccessful), as shown at 504. It is then determined if the call back timer has expired, as shown at 506. If the call back timer is determined to have not expired at 506, then the EM 280 checks to determine whether the escalation timer has expired, as shown at 508. It is then determined if the escalation timer has expired, as shown at 510. If it is determined at 510 that the escalation timer has not expired, then the method involves pausing, e.g., waiting for a predetermined period of time, for a next holding iteration, as shown at 512. Method flow then returns to 504, where the EM 280 again checks for expiration of the call back timer, and the method flow continues as described above.

If, however, it is determined at 510 that the escalation timer has expired then the method flow continues to 514, where the EM 280 logs that the escalation timer has expired, as shown at 514. The method flow then returns to the previous workflow, as shown at 516, and the method ends, as shown at 517.

If, however, it is determined at 506 that the calling timer has expired then the EM 280 calls (in this embodiment) the resource and logs another attempt to contact the resource, as shown at 518. It is then determined whether the resource (e.g., service provider) has answered the telephone call (in this example) as shown at 520. If it is determined at 520 that the resource has not answered the phone call, then the system 200, e.g. EM 280, leaves a voicemail message for the resource (e.g. using a script and or a pre-recording and/or synthesized text to speech, in a manner similar to that described above), as shown at 522 and method flow returns to 508 where the EM 280 again checks whether the escalation timer has expired, and the method flow continues as described above.

If, however, it is determined at 520 that the resource did answer the telephone call (in this example) then the EM 280 logs that the reserves answered, e.g., as Connection Data 224e, as shown at 524. The method flow then returns to the previous workflow, as shown at 516, and the method ends, as shown at 517.

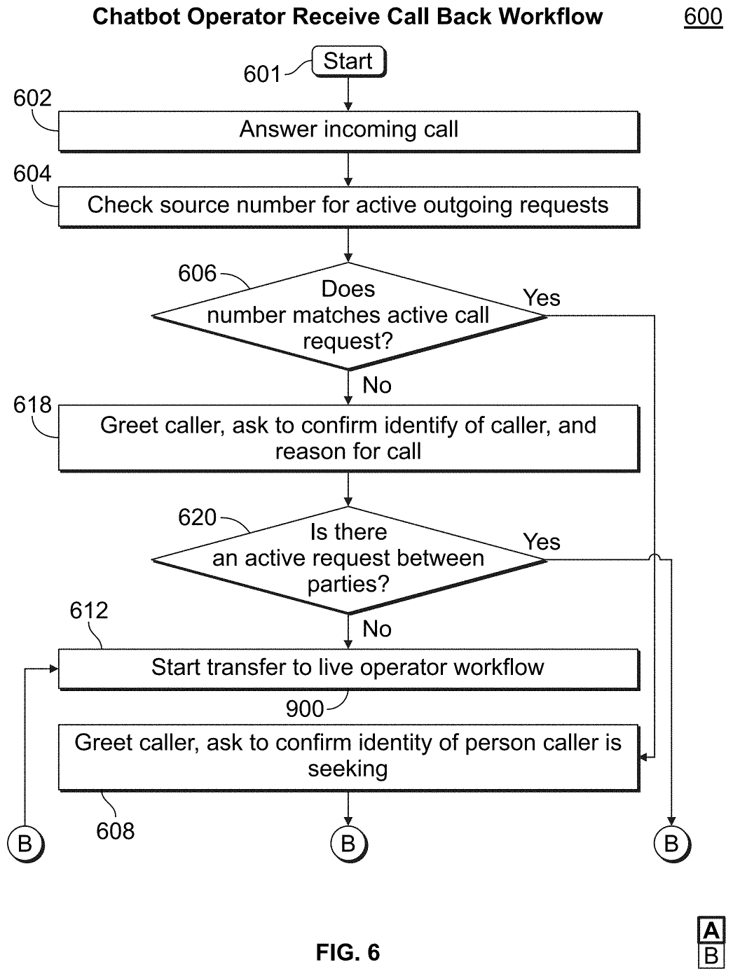

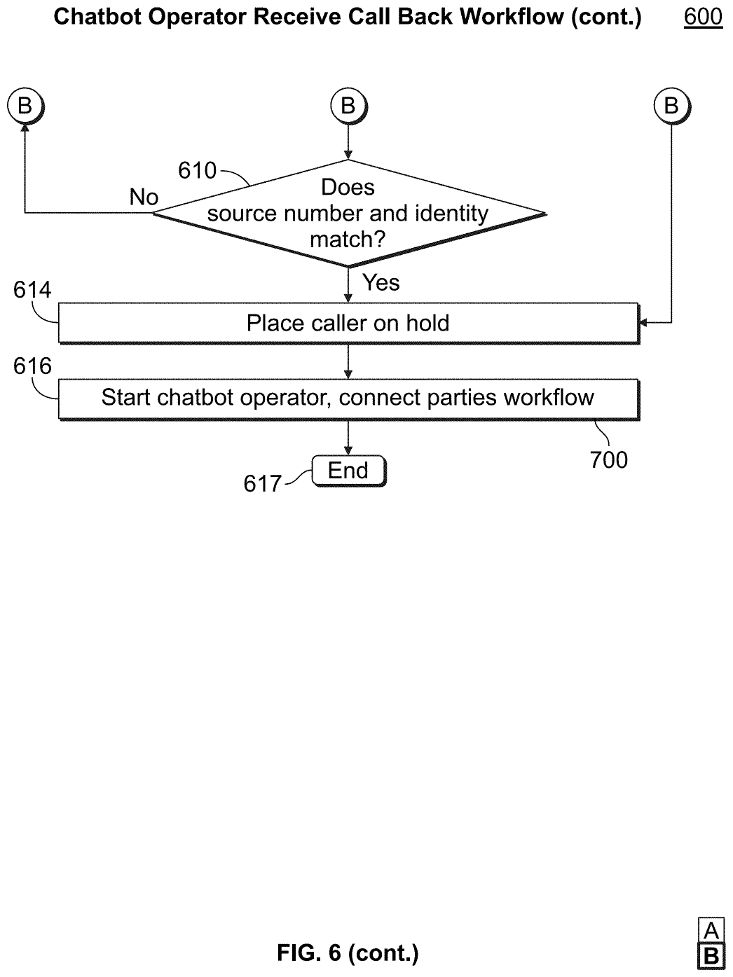

FIG. 6 illustrates an exemplary method of operation of the EM 280 for receiving a call back from the resource service provider, e.g., after leaving a message requesting a call back after the resource provider did not answer a telephone call. In this exemplary method, the method starts 601 with the EM 280 (e.g., in collaboration with other system components) answering an incoming telephone call, as shown at 602 this may involve operation of the Connection Module 290. The EM 280 then checks the telephone number of the incoming call (e.g., using caller ID-type functionality) and compares it to active outgoing attempts to contact resources and determining whether the telephone number for the incoming call match is a telephone number for an outgoing request, as shown at 604 this may involve, for example, referencing stored Connection Data 224e associated with failed connection attempts that were logged. It is then determined that 606 whether the telephone number for the incoming call matches the telephone number of an outgoing call to a resource.

If it is determined at 606 that the telephone numbers match, then the EM 280 provides a message, e.g., using text to speech functionality, to greet the caller, asked the caller to confirm the caller's identity, in a manner similar to that described above, as shown at 608. It is then determined whether the incoming telephone number matches the identity of the requested resource, as shown at 610. If not, then EM 280 starts a transfer to live operator workflow 900, as shown at 612.

If, however, it is determined at 610 that the incoming telephone number and identity of the resource do match. Then the EM 280 places the caller on hold, as shown at 614, and starts the Connect Parties Workflow 700, as shown at 616, and the method ends, as shown at 617.

If, however, it is determined that 606 that the incoming telephone number does not match a telephone number of an active call request, then the EM 280 provides a message, e.g., using text to speech functionality, to greet the caller, ask the caller to confirm the caller's identity, and asks the caller to identify a reason for the call, as shown at 618, in a manner similar to that described above. It is then determined whether there is an active request open with respect to the caller and/or an associated resource, as shown at 620. If so then the caller is placed on hold, as shown at 614, and the method continues as described above. If not, then EM 280 starts a transfer to live operator workflow 900, as shown at 612.

FIG. 7 illustrates the Connect Parties Workflow method 700 of FIGS. 3 and 6. Referring now to FIG. 7, the exemplary method starts with the Connection Module 290 contacting the original requestor, as shown at 701 and 702 (e.g., after successfully contacting a resource and placing the resource's phone call on hold as described above). This may involve placing an automated telephone call to the original requestor (e.g., via the Requestor Telephone 80) that had requested a particular resource, which has since been identified by the ISMC 200. This may involve retrieval of contact data for the original resource Requestor from the Contact Data 224d stored in the data store 224.

It is then determined whether the requester has responded to the initiated contact, e.g., by answering a telephone call, as shown at 704. If the Requestor does answer the telephone call, then the CM 290 may act somewhat like an automated switchboard operator to open a telephone connection (or in certain embodiments, enables a different communication channel or facilitates communication via a different communication channel) between the identified resource provider and the original Requestor, as shown at 706. This allows the parties to communicate directly (e.g., by telephone), exchange information, and allows the requestor to receive the requested resource (e.g., consultation) from the resource provider (e.g., nephrologist). The CM 290 may then log the connection between the caller (resource/service provider) and the original requestor, as shown at 708. The CM 290 may store data reflecting the successful connection and proper match of resource provider to request as Selection Data 224c for future reference and/or as Connection Data 224e. This exemplary method then ends, as shown at 709.

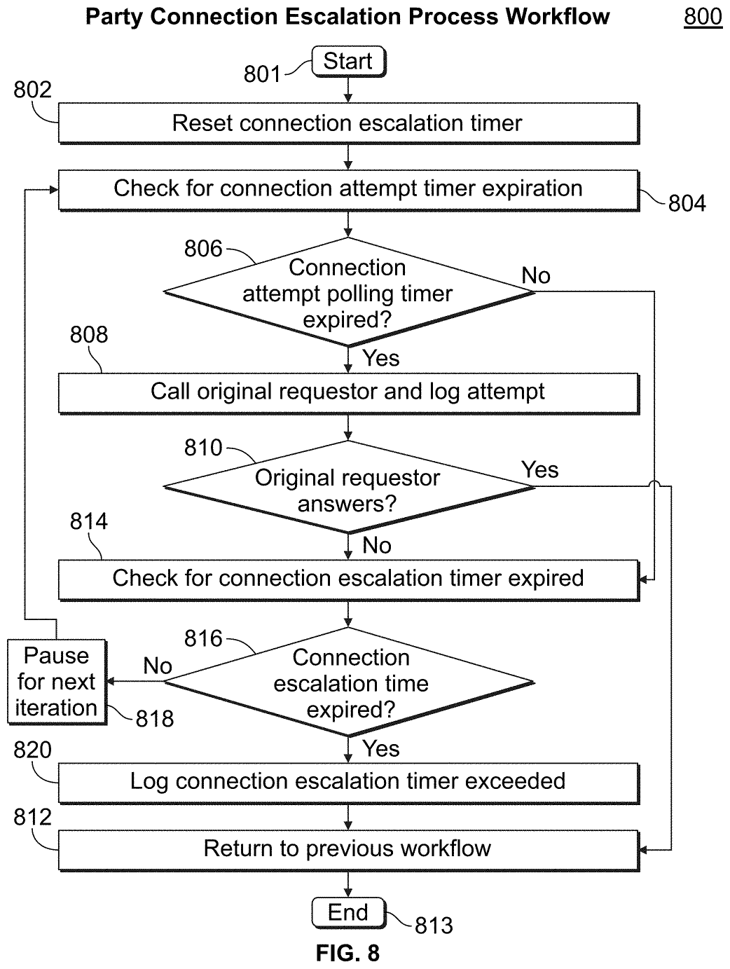

If, however, it is determined at 704 that the requester has not responded, e.g., by answering the telephone call, then the EM 280 may start a Party Connection Escalation Workflow 800, discussed below with reference to FIG. 8. This Party Connection Escalation Workflow 800 may result in another attempt to call the identified Requestor, until a timeout condition occurs, etc., as described with reference to FIG. 8.

If is then determined whether a communication connection was successfully established with the requestor, as shown at 710. If so, then the method flow continues to 706 where the CM 290 opens a telephone or other connection between the identified resource provider and the original requestor, as described above, and the method flow continues as described above.

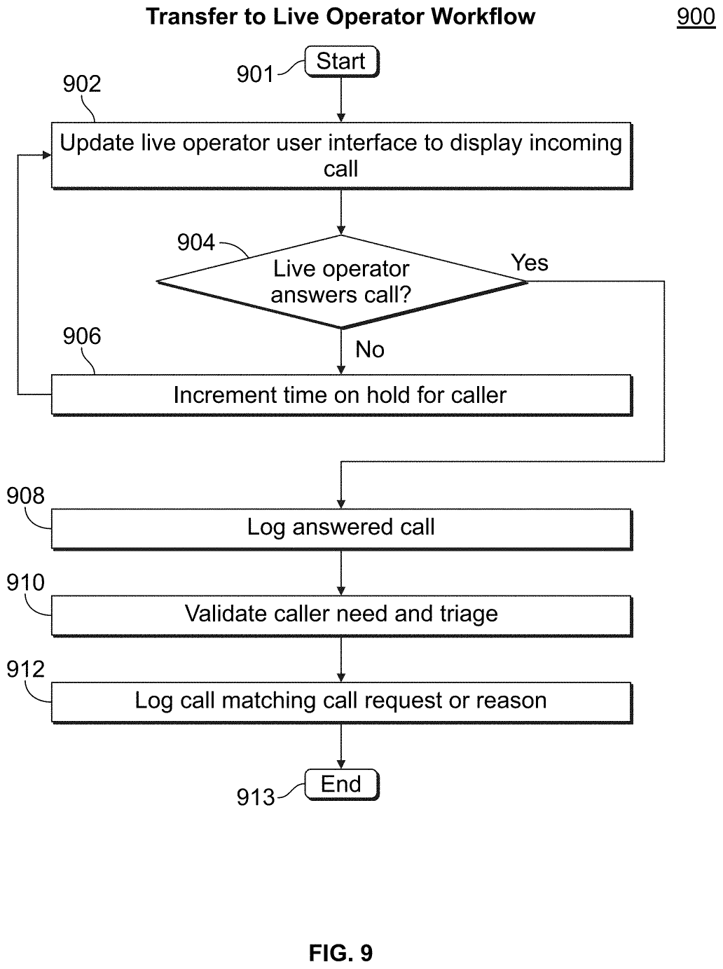

If it is determined at 710 that a connection was not successfully established with the requestor, then the CM 290 logs the failed connection attempt, as shown at 712. This may involve recording data as Selection Data 224c for future reference and/or as Connection Data 224e. The method flow then continues to the Transfer to Live Operator Workflow 900, as described below with reference to FIG. 9), and the method ends, as shown at 709.

FIG. 8 illustrates the Party Connection Escalation Workflow method of FIG. 7, for the purpose of re-attempting connection to a particular resource provider after a prior attempt is unsuccessful. Referring now to FIG. 8, the exemplary method starts with the Escalation Module 280 starting/resetting a connection escalation timer, as shown at 802. Next, the EM 280 checks for expiration of the connection attempt timer, as shown at 804. It is then determined if the connection attempt timer has expired, as shown at 806. If the connection attempt timer is determined to have not expired at 806, then the EM 280 checks to determine whether the escalation timer has expired, as shown at 814. It is then determined if the connection escalation timer has expired, as shown at 816. If it is determined at 816 that the connection escalation timer has not expired, then the method involves pausing, e.g., waiting for a predetermined period of time, for a next iteration, as shown at 818. Method flow then returns to 804, where the EM 280 again checks for expiration of the connection attempt timer, and the method flow continues as described above.

If, however, it is determined at 816 that the connection escalation timer has expired then the method flow continues to 820, where the EM 280 logs that the escalation timer has expired, as shown at 820. The method flow then returns to the previous workflow, as shown at 812, and the method ends, as shown at 813.

If, however, it is determined at 806 that the connection attempt timer has expired then the EM 280 calls (in this embodiment) the requestor and logs the attempt to contact the requestor, as shown at 808. It is then determined whether the requestor has answered the telephone call (in this example) as shown at 810. If it is determined at 810 that the requestor has not answered the phone call, then the system 200, e.g., EM 280, checks the connection escalation time, as shown at 814 and the method flow continues as described above.

If, however, it is determined at 810 that the resource did answer the telephone call (in this example) then the method flow then returns to the previous workflow, as shown at 812, and the method ends, as shown at 813.

FIG. 9 illustrates the Transfer to Live Operator Workflow method 900 of FIGS. 6 and 7. Referring now to FIG. 9, the exemplary method starts with the Connection Module 290 updating a user interface to display an incoming telephone call (in this example), as shown at 901 and 902. In this example, this involves causing a display (e.g., as the result of a data communication from the ICMS 200 via the communications network 50) in an administrative computer device display interface of a Live Operator System 150 used by live human operators. By way of example, the Live Operator System 150 may be a smartphone or other telephone device with the display, or a personal computer or other type of computing system in conjunction with a telephone device, or a personal computer or other type of computing device capable of handling telephone calls. This may involve placing an automated telephone call (in this example) to the live operator (in this embodiment), for display via the Live Operator System 150.

It is next determined whether a live operator has answered the call, as shown at 904. If it is determined in 904 that the live operator did not answer the call, then caller may be kept on hold, and a timer may be used to time a next attempt, as shown at 906. Method flow then continues to 902 and proceeds as described above.

If, however, it is determined at 904 that the live operator answered the call, then the CM 290 logs the answering of the call, as shown at 908, which may involve storing Selection Data 224c and/or Connection Data 224e, as described above. Next the live operator may conduct a telephone discussion with the requestor that requested the resource, identify/validate the caller's need and triage in a manual fashion during the connected communication session, as shown at 910. The live operator will then manually match the call with a suitable service provider, as shown at 912, and record associated data as Selection Data 224c and/or Connection Data 224e, so that the system may subsequently learn from this manual matching (following failed automated matching by the system), to make a better, more accurate match in a future iteration of the process. This exemplary method then ends.

Accordingly, it will be appreciated that the present invention provides a system and method that can lessen the burden on a resource requestor, and/or reduce or eliminate the need to identify which resource provider has sufficient capacity for providing and is most relevant to the requested resource, thereby affording the requestor an opportunity to continue be productive at other tasks, rather than having to research resource providers, select preferred resource provides, contact resource providers, waste time waiting “on hold,” re-attempting call inquiries, and/or speaking with resource providers lacking present capacity for providing the requested resource.

Further, the system and method of the present invention provide a method and system for management of multi-party communications that is capable of intelligently assessing a first party/requestor's need and matching the first party need to a suitable second party resource that is most probable to meet that need in an efficient manner. The system effectively serves as a chatbot-based switchboard operator that allows requestors to state a need for a service or consultation, and then automatedly have that need researched and/or matched to the most appropriate resource/service provider based on real-time automated inquiry and/or known data from past research. Further, the system is capable of contacting one or more resources/service providers, confirming that a particular resource/provider can meet the current need, and also coordinating/facilitating a communication session between the first party/requestor and the second party/resource without the need for human intervention.

This system and method of the present invention principally relies upon several elements. One of those elements is a computerized communication management engine that can interface with a resource requestor/user to understand the service/consultant/resource provider/resource that is needed. This is done via a computerized, automated “bot” interface (via a voice-based or text-based platform). After the need has been identified, the requestor can continue with other tasks and wait for the system to asynchronously facilitate a communication session with a suitable service provider.

When a need has been identified, the computerized communication management engine routes the need to a relevant resource provider that has the best chance of meeting the request for the resource based on trained models coupled with known request volume, and attempts to contact the resource provider via phone, text, or application. The computerized communication management engine starts an interactive session to validate the resource provider's identity, confirm the resource/service needed, and confirm that resource provider has the current capacity to meet the requestor's need. If any of the above conditions is not met, the computerized communication management engine will record why the match was not made and attempt a session with the next most-likely service provider. The computerized communication management engine uses success and failure to inform its future triage functionality in selecting a suitable resource provider.

After the validation process is complete, the computerized communication management engine will notify the original requestor that a suitable resource provider has been found and is available to provide the requested resource/service. The computerized communication management engine then enables or facilitates a communication session for the parties, so that the requested resource may be obtained.

Lastly, the computerized communication management engine learns based on datapoints recorded for each interaction, including if the need for a requested resource was met successfully. Information is logged to inform future requests. This is used to prioritize the resource providers that the computerized communication management engine will attempt to contact based on time of day, volume of requests, and success or failure rates, etc.

At any point during this process, if a connection fails to be made, or repeated attempts have been unsuccessful, the system will escalate the need to a human operator or follow up with the initial requestor with the status.

Accordingly, a system in accordance with the present invention may be used, for example, by companies that benefit from efficient communication to meet the business needs within the organization, by companies that benefit from efficiently aligning needs to resources outside of the organization, by companies that would benefit from asynchronous communication channel coordination, and by individuals that need a service or consultant for a specific need but who do not have the time to manually vet and contact potential service/consultant options.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. An intelligent communication management system comprising:
a memory operatively comprising a non-transitory data processor-readable medium;
a data processor operatively connected to the memory;
a communication management engine comprising instructions stored in the memory and executable by the data processor to:
receive a request for a resource from a resource requestor;
identify at least one resource provider capable of providing the requested resource;
communicate with said at least one resource provider to confirm suitability of said at least one resource provider for providing the requested resource; and
after confirming suitability of said at least one resource provider for providing the requested resource, facilitate a communication session between the resource requestor and said at least one resource provider to enable said resource requestor to obtain said requested resource from said resource provider.

2. The intelligent communication management system of claim 1, further comprising instructions stored in the memory and executable by the data processor to:
process the request to identify the resource.

3. The intelligent communication management system of claim 1, wherein said instructions stored in the memory and executable by the data processor to identify at least one resource provider capable of providing the requested resource comprises instructions to:
reference a data store to identify the at least one resource provider from a plurality of resource providers according to criteria of the request.

4. The intelligent communication management system of claim 1, wherein said instructions stored in the memory and executable by the data processor to identify at least one resource provider capable of providing the requested resource comprises instructions to:
reference the data store to select a subset of the suitable resource providers that are preferred.

5. The intelligent communication management system of claim 1, wherein said instructions stored in the memory and executable by the data processor to identify at least one resource provider capable of providing the requested resource comprises instructions to:
rank a plurality of resource providers on the basis of criteria comprising at least one of availability, an average response time to a request, and a satisfaction rating.

6. The intelligent communication management system of claim 5, wherein said instructions stored in the memory and executable by the data processor to communicate with said at least one resource provider to confirm suitability of said at least one resource provider for providing the requested resource comprises instructions to:
perform automated querying of at least two resource providers via placement of at least one telephone call to a resource provider in order of a ranking of the plurality of resource providers.

7. The intelligent communication management system of claim 1, wherein said instructions stored in the memory and executable by the data processor to communicate with said at least one resource provider to confirm suitability of said at least one resource provider for providing the requested resource comprises instructions to:
perform automated querying via placement of at least one telephone call to a resource provider.

8. The intelligent communication management system of claim 1, wherein said instructions stored in the memory and executable by the data processor to, after confirming suitability of said at least one resource provider for providing the requested resource, facilitate a communication session between the resource requestor and said at least one resource provider to enable said resource requestor to obtain said requested resource from said resource provider comprises instructions to:
place on hold a telephone call with said at least one resource provider;
place a telephone call to the resource requestor; and
join the at least one resource provider and the resource requestor in a common telephone call session.

9. A computer-implemented method for intelligent communication management, the computerized device comprising a memory operatively comprising a non-transitory data processor-readable medium, a data processor operatively connected to the memory, and a communication management engine, the method comprising:
receiving a request for a resource from a resource requestor;
identifying at least one resource provider for providing the requested resource;
communicating with said at least one resource provider to confirm suitability of said at least one resource provider for providing the requested resource; and
after confirming suitability of said at least one resource provider for providing the requested resource, facilitating a communication session between the resource requestor and said at least one resource provider to enable said resource requestor to obtain said requested resource from said resource provider.

10. The method of claim 9, further comprising:
processing the request to identify the resource.

11. The method of claim 9, wherein said identifying at least one resource provider capable of providing the requested resource comprises:
referencing a data store to identify the at least one resource provider from a plurality of resource providers according to criteria of the request.

12. The method of claim 9, wherein said identifying at least one resource provider capable of providing the requested resource comprises:
referencing the data store to select a subset of the suitable resource providers that are preferred.

13. The method of claim 9, wherein said identifying at least one resource provider capable of providing the requested resource comprises:
ranking a plurality of resource providers on the basis of criteria comprising at least one of availability, an average response time to a request, and a satisfaction rating.

14. The method of claim 13, wherein said communicating with said at least one resource provider to confirm suitability of said at least one resource provider for providing the requested resource comprises:
performing automated querying of at least two resource providers via placement of at least one telephone call to a resource provider in order of a ranking of the plurality of resource providers.

15. The method of claim 9, wherein said communicating with said at least one resource provider to confirm suitability of said at least one resource provider for providing the requested resource comprises:
performing automated querying via placement of at least one telephone call to a resource provider.

16. The method of claim 9, wherein said facilitating a communication session between the resource requestor and said at least one resource provider to enable said resource requestor to obtain said requested resource from said resource provider comprises:
placing on hold a telephone call with said at least one resource provider;
placing a telephone call to the resource requestor; and
joining the at least one resource provider and the resource requestor in a common telephone call session.

17. A computer program product for intelligent communication management, the computer program product comprising a non-transitory computer-readable medium storing executable instructions that, when executed by a processor, cause an intelligent communication management system to perform a method comprising:
receiving a request for a resource from a resource requestor;
identifying at least one resource provider for providing the requested resource;
communicating with said at least one resource provider to confirm suitability of said at least one resource provider for providing the requested resource; and
after confirming suitability of said at least one resource provider for providing the requested resource, facilitating a communication session between the resource requestor and said at least one resource provider to enable said resource requestor to obtain said requested resource from said resource provider.

18. The computer program product of claim 17, further comprising executable instructions that, when executed by a processor, cause an intelligent communication management system to perform the method comprising:
processing the request to identify the resource.

19. The computer program product of claim 17, wherein said instructions stored in the memory and executable by the data processor to identify at least one resource provider capable of providing the requested resource comprises instructions to perform the method comprising:
referencing a data store to identify the at least one resource provider from a plurality of resource providers according to criteria of the request.

20. The computer program product of claim 17, wherein said instructions stored in the memory and executable by the data processor to identify at least one resource provider capable of providing the requested resource comprises instructions to perform the method comprising:
referencing the data store to select a subset of the suitable resource providers that are preferred.

21. The computer program product of claim 17, wherein said instructions stored in the memory and executable by the data processor to identify at least one resource provider capable of providing the requested resource comprises instructions to perform the method comprising:
ranking a plurality of resource providers on the basis of criteria comprising at least one of availability, an average response time to a request, and a satisfaction rating.

22. The computer program product of claim 21, wherein said instructions stored in the memory and executable by the data processor to communicate with said at least one resource provider to confirm suitability of said at least one resource provider for providing the requested resource comprises instructions to perform the method comprising:
performing automated querying of at least two resource providers via placement of at least one telephone call to a resource provider in order of a ranking of the plurality of resource providers.

23. The computer program product of claim 17, wherein said instructions stored in the memory and executable by the data processor to communicate with said at least one resource provider to confirm suitability of said at least one resource provider for providing the requested resource comprises instructions to perform the method comprising:
performing automated querying via placement of at least one telephone call to a resource provider.

24. The computer program product of claim 17, wherein said instructions stored in the memory and executable by the data processor to, after confirming suitability of said at least one resource provider for providing the requested resource, facilitate a communication session between the resource requestor and said at least one resource provider to enable said resource requestor to obtain said requested resource from said resource provider comprises instructions to perform the method comprising:
placing on hold a telephone call with said at least one resource provider;
placing a telephone call to the resource requestor; and
joining the at least one resource provider and the resource requestor in a common telephone call session.
